(19) United States
(12) Patent Application Publication
(10) Pub. No.: US 2016/0264276 A1
(43) Pub. Date: Sep. 15, 2016

(54) METHOD FOR PRODUCING POLYCRYSTALLINE SILICON

(71) Applicant: WACKER CHEMIE AG, München (DE)

(72) Inventors: Rainer HOELZLWIMMER, Neuoetting (DE); Matthias VIETZ, Mattighofen (AT)

(21) Appl. No.: 15/036,888

(22) PCT Filed: Nov. 5, 2014
(86) PCT No.: PCT/EP2014/073798

§ 371 Date: May 16, 2016

(30) Foreign Application Priority Data
Nov. 22, 2013 (DE) 10 2013 223 883.5

(51) Int. Cl. B65B 67/02; B02C 23/08; B65B 25/00; C01B 33/02

(52) U.S. Cl. CPC B65B 67/02; C01B 33/02; B02C 23/08; B65B 25/00

(57) ABSTRACT

Improved polycrystalline silicon manufacture is achieved by providing polycrystalline silicon rods, comminuting the polycrystalline silicon rods into polycrystalline silicon chunks, and packing the polycrystalline silicon chunks by introducing the polycrystalline silicon chunks into a solid and intrinsically stable container comprising a base, a wall and an opening, the container having the form of a truncated cone or truncated pyramid with two different-sized areas of base and opening and with a lateral surface, the base area being greater than the area of the opening of the container, the wall of the container having a thickness of at least 0.5 mm, and an angle between a lateral line and a vertical axis of cone or pyramid being at least 2°.

### CROSS REFERENCE TO RELATED APPLICATIONS

This application is the U.S. National Phase of PCT Appln. No. PCT/EP2014/073798 filed Nov. 5, 2014, which claims priority to German Application No. 10 2013 223 883.5 filed Nov. 22, 2013, the disclosures of which are incorporated in their entirety by reference herein.

### BACKGROUND OF THE INVENTION

1. Field of the Invention

The invention relates to a method for producing polycrystalline silicon.

2. Description of the Related Art

Polycrystalline silicon (polysilicon) is deposited predominantly by means of the Siemens process from halosilanes such as trichlorosilane onto thin rods, giving polycrystalline silicon rods, which are subsequently comminuted in a very low-contamination procedure into polycrystalline silicon chunks.

For applications in the semiconductor and solar industries, the desire is for a chunk polysilicon with very little contamination. The material ought therefore to be packed in a low-contamination manner as well, before being transported to the customer.

Tubular pouch machines with suitability, in principle, for the packing of chunk silicon are available commercially. One such packing machine is described in DE 36 40 520 A1, for example.

Chunk polysilicon is a sharp-edged, non-free-flowing bulk material. At the packing stage, therefore, care must be taken to ensure that the material does not puncture the usual plastic pouches during filling, or, in the worst case, even destroy them completely.

To prevent this happening, the commercial packing machines must be suitably modified for the packing of polysilicon, for the reason that the plastic pouch becomes punctured, leading likewise to the line being halted and the silicon being contaminated.

DE 10 2007 027 110 A1 discloses a method for packing polycrystalline silicon wherein polycrystalline silicon is filled by means of a filling device into a freely suspended, completely formed pouch, the filled pouch being subsequently sealed, characterized in that the pouch consists of high-purity plastic having a wall thickness of 10 to 1000 μm, with the filling device comprising a freely suspended energy absorber made of a nonmetallic, low-contamination material, which is introduced into the plastic pouch before the polycrystalline silicon is introduced, and via which the polycrystalline silicon is introduced into the plastic pouch, and the freely suspended energy absorber is subsequently removed from the plastic pouch filled with polycrystalline silicon, and the plastic pouch is sealed. The sealing of the plastic pouch is accomplished typically by welding.

By means of a method of this kind that provides for an energy absorber within the plastic pouch, punctures to the plastic pouch in the course of packing can be largely prevented. This is the case, however, only for small and/or lightweight chunks. It has been found that the risk of pouch damage incidents increases in proportion with the mass of the chunk.

One possibility conceivable in principle for reducing the puncture rate, by reinforcement of the pouch film, has proven not very practicable, especially since a less flexible film of this kind would be difficult to handle. The packing machines that are in use are not designed for films with a thickness of more than 350 μm. Moreover, the time needed to weld pouches of such thickness would be longer, thus reducing the throughput.

Such punctures to the pouch may occur not only in the course of packing, but also in the course of transport to the customer. Chunk polysilicon is sharp-edged, and so in the event of unfavorable orientation of the chunks in the pouch as a result of the chunks moving relative to the pouch film and/or exerting pressure on the pouch film, they sever or puncture this film.

Experience has shown that pouches made from standard commercial PE films, filled with chunk polysilicon, exhibit torn-open weld seams during or after transport.

Chunks sticking out from the pouch packaging may receive unacceptable contamination directly by surrounding materials, while chunks on the inside may be unacceptably contaminated by inflowing ambient air.

This problem is found even with the so-called double pouches, where the polysilicon is filled into a first pouch and this first pouch is introduced subsequently into a second pouch.

In spite of all the measures known in the prior art, 100% visual inspection for punctures and pouch damage is always required.

The objective of the invention developed from these problems.

### SUMMARY OF THE INVENTION

The object is achieved by means of a method for producing polycrystalline silicon, which comprises providing polycrystalline silicon rods, comminuting the polycrystalline silicon rods into polycrystalline silicon chunks, and packing the polycrystalline silicon chunks by introducing the polycrystalline silicon chunks into a solid and intrinsically stable container comprising a base, a wall and an opening, the container having the form of a truncated cone or truncated pyramid with two different-sized areas of base and opening and with a lateral surface, the base area being greater than the area of the opening of the container, the wall of the container having a thickness of at least 0.5 mm, and an angle between a lateral line and a vertical axis of cone or pyramid being at least 2°.

### DETAILED DESCRIPTION OF THE PREFERRED EMBODIMENTS

The polycrystalline silicon is deposited preferably on heated thin silicon rods, using as reaction gas a silicon-containing component and hydrogen (Siemens process). The silicon-containing component is preferably a chlorosilane, more preferably trichlorosilane. Deposition takes place in accordance with the prior art, with reference to WO 2009/047107 A2, for example.

Following deposition, the polycrystalline silicon rods are comminuted. Preferably there is first a preliminary comminution of the polysilicon rods. For this precomminution a hammer is used that is made of a low-abrasion material, e.g., hard metal. Precomminution takes place on a workbench with a surface consisting preferably of low-wear plastic or of silicon.

This is followed by a comminution of the precomminuted polysilicon to the desired target chunk size 0, 1, 2, 3, or 4. Chunk size is defined as the greatest distance between two points on the surface of a silicon chunk (=max. length), as follows:

Chunk size 0 in mm: about 0.5 to 5

Chunk size 1 in mm: about 3 to 15

Chunk size 2 in mm: about 10 to 40

Chunk size 3 in mm: about 20 to 60

Chunk size 4 in mm: about >45

Comminution is accomplished by means of a crusher, a jaw crusher for example. One such crusher is described in EP 338 682 A2, for example.

Thereafter the crushed silicon is classified into the above chunk sizes, by means of a mechanical screen where appropriate.

The chunks are optionally cleaned prior to packing. For this purpose a cleaning solution comprising HNO₃ and HF is used with preference.

In a preliminary cleaning operation, preferably, the polysilicon chunks are washed in at least one stage with an oxidizing cleaning solution, washed in a main cleaning operation in a further stage with a cleaning solution comprising HNO₃ and HF, and washed in a hydrophilization procedure, in yet a further stage, with an oxidizing cleaning fluid. Preliminary cleaning is accomplished preferably by means of HF/HCl/H₂O₂. The hydrophilization of the silicon surface is accomplished preferably by means of HCl/H₂O₂.

After cleaning or directly after comminution (if no cleaning takes place), the polysilicon chunks are packed.

The base area of the container may be circular or elliptical (truncated cone). A truncated cone is produced by cutting off a smaller cone from a right circular cone parallel to the base area.

It is also preferred if the base area is square or rectangular (tetragonal) or is a polygon (truncated pyramid). A truncated pyramid is formed by cutting off a smaller, similar pyramid (complementary pyramid) from a pyramid (starting pyramid) parallel to the base area.

The two parallel surfaces of a truncated pyramid are similar to one another. The truncated pyramid has a plurality of lateral surfaces, each with lateral lines, and these lateral lines can form different angles with a vertical axis of the pyramid. All of the lateral lines of the truncated pyramid are to form an angle of at least 2° with the vertical axis of the pyramid.

The container employed is therefore preferably a solid and intrinsically stable container comprising a base, a wall, and an opening, where the container has the form of a truncated cone with two different-sized circular areas and a lateral surface, the circular base area being greater than the circular area of the opening of the container, the wall of the container having a thickness of at least 0.5 mm, and an angle between a lateral line and a vertical cone axis being at least 2°.

The container may also have the form of a truncated pyramid. In this case the base area may be square, rectangular, or a polygon. In this case the opening as well has a square form, a rectangular form, or the form of a polygon. Here as well it is essential that an angle between any lateral line and a vertical axis is at least 2°.

The wall of the container preferably has a thickness of 0.6 mm to 1 mm.

The angle between a lateral line and a vertical cone axis is preferably 2° to 6.5°.

The opening of the container can be closed by means of a lid.

The container consists preferably of a plastic.

The plastic used contains preferably less than 100 ppbw boron, less than 100 ppbw phosphorus, and less than 10 ppbw arsenic.

The plastic is preferably selected from the group consisting of polypropylene, polyethylene, polyurethane, and polyvinylidene fluoride (PVDF).

It has emerged that the silicon chunks located inside the container are jammed by its inclined wall. This has the advantage, relative to the existing packaging for polysilicon, that the silicon chunks are also fixed in the course of transport. There are no relative movements of the chunks in the container. Hence it is possible to prevent unwanted further comminution of the material in the course of transport.

During packing, the chunks can be metered directly into the container. Standard packing machines or robots with gripper arms may be employed. Relatively little fines content is produced in the course of container filling.

If the container is filled manually, gloves of high-purity polyethylene or of PU are preferably used. The material of which the gloves consist ought to contain less than 100 ppbw boron, less than 100 ppbw phosphorus, and less than 10 ppbw arsenic.

With the pouches in the prior art it was necessary as a general rule to preform the pouches, by means for example of a forming tube or by the pouch being pulled over a shoulder. This is done away with in the method of the invention, since a solid, intrinsically stable vessel is employed. The puncture problems known from the prior art do not occur.

There is no need for the visual inspection for packaging material damage as in the prior art.

The filled containers can be packed automatically into a cardboard transport box.

The containers preferably comprise service elements, mounted on the outer wall of the container, in order to allow the containers to be gripped and held.

For the packing of the containers into the cardboard transport box, robots with gripper arms or roller conveyors may be employed.

The packing of the containers into the cardboard transport box is preferably done in such a way that the box volume is utilized to the optimum and a maximum packing density is achieved.

1.-10. (canceled)

11. A method for producing polycrystalline silicon, which comprises providing polycrystalline silicon rods, comminuting the polycrystalline silicon rods into polycrystalline silicon chunks, and packing the polycrystalline silicon chunks by introducing the polycrystalline silicon chunks into a solid and stable container comprising a base, a lateral wall and an opening, the container having the form of a truncated cone or truncated pyramid wherein the areas of the base and opening are different, the base area being greater than the opening area of the container, the base and lateral wall(s) of the container having a thickness of at least 0.5 mm, and wherein an angle between a lateral line and a vertical axis of the truncated cone or pyramid is at least 2°.

12. The method of claim 11, wherein the base of the container is circular or elliptical.

13. The method of claim 11, wherein the base of the container is square, rectangular, or polygonal.

14. The method of claim 11, wherein the base and wall(s) of the container has a thickness of 0.6 mm to 1 mm.

15. The method of claim 11, wherein the angle between a lateral line and a vertical axis of the truncated cone or pyramid is 2° to 6.5°.

16. The method of claim 11, wherein the container comprises a plastic containing less than 100 ppbw boron, less than 100 ppbw phosphorus, and less than 10 ppbw arsenic.

17. The method of claim 16, wherein at least one plastic is selected from the group consisting of polypropylene, polyethylene, polyurethane, and polyvinylidene fluoride.

18. The method of claim 11, where the polycrystalline silicon chunks are introduced manually into the container, with gloves of PE or PU being worn that contain less than 100 ppbw boron, less than 100 ppbw phosphorus, and less than 10 ppbw arsenic.

19. The method of claim 11, wherein the polycrystalline silicon chunks before being packed are cleaned with a cleaning solution comprising HNO₃ and HF.

20. The method of claim 11, wherein the polycrystalline silicon chunks are classified into chunk size classes before they are packed or optionally cleaned.
